(19) United States
(12) Patent Application Publication
(10) Pub. No.: US 2005/0210246 A1
(43) Pub. Date: Sep. 22, 2005

(54) Secure email service

(75) Inventor: Patrick R. Faure, Fairport, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/075,678

(22) Filed: Mar. 9, 2005

Related U.S. Application Data
(60) Provisional application No. 60/553,591, filed on Mar. 16, 2004.

(51) Int. Cl. H04L 9/00

(52) U.S. Cl. 713/167

(57) ABSTRACT

A secure email system and method. The method comprises the steps of: receiving an encrypted email from an sender intended for transmission to a predetermined recipient, wherein the email's encryption is based on a first encryption key and the first encryption key is not stored at the remote location; de-encrypting the received encrypted email using the first encryption key, the first encryption key being stored at the server location; determining a second encryption key associated solely with the predetermined recipient of the email; re-encrypting the de-encrypted email using an encryption based on the second encryption key; and transmitting the re-encrypted email to the predetermined recipient located at a recipient location remote from the server location whereby the predetermined recipient can de-encrypt the re-encrypted email at the recipient location using the second encryption key.

### CROSS REFERENCE TO RELATED APPLICATION

Reference is made to and priority is claimed from commonly assigned U.S. Provisional Application Ser. No. 60/553,591, filed Mar. 16, 2004, entitled SECURE EMAIL SERVICE, incorporated herein by reference.

### FIELD OF THE INVENTION

The invention relates generally to the secure transmission of an electronic mail message, and more particularly to a secure email service.

### BACKGROUND OF THE INVENTION

Sending of electronic mail messages (often referred to as email) is well known. It has been recognized that there is a need to protect/secure the transmission of such electronic mail messages. For example, to ensure that the intended recipient receives the transmission and/or ensure that the contents of the email were not misappropriated or modified by another prior to be received by the recipient.

U.S. Pat. No. 6,584,564 (Olkin) is directed to a secure email system permitting a sender to send a secure email to one or more receivers.

US Application Publication No. 2003/0217259 (Wong) is directed to a method and apparatus for web-based secure email.

While such systems/methods may be appropriate for their particular application, there exists a need for a secure email service/system which encrypts email messages and attachments, and allows for the secure exchange of electronic documents, particularly medical records.

### SUMMARY OF THE INVENTION

An object of the present invention is to provide an apparatus and method for the secure transmission of an electronic mail message.

Another object of the present invention is to provide an apparatus and method for a secure email service.

The present invention is directed a system which encrypts email messages and attachments, and allows for the secure exchange of electronic documents, for example, medical records.

Accordingly to one aspect of the present invention, there is provided a method of processing an email. The method comprises the steps of: receiving, at a server location, an encrypted email from an sender intended for transmission to a predetermined recipient, wherein the email's encryption is based on a first encryption key and the first encryption key is not stored at the remote location, the encrypted email being sent from a sender location remote from the server location; de-encrypting, at the server location, the received encrypted email using the first encryption key, the first encryption key being stored at the server location; at the server location, determining a second encryption key associated solely with the predetermined recipient of the email; re-encrypting the de-encrypted email using an encryption based on the second encryption key; and transmitting the re-encrypted email to the predetermined recipient located at a recipient location remote from the server location whereby the predetermined recipient can de-encrypt the re-encrypted email at the recipient location using the second encryption key.

According to another aspect of the present invention, there is provided an email processing system for processing an email transmitted from a sender intended for a particular recipient. The system includes a server, communication means, a sending unit, and a recipient unit. The server includes a database of recipient encryption keys wherein each recipient encryption key is uniquely associated with a particular recipient. The communication means is in communication with the server to allow the server to receive an email from a sender and transmit an email to a recipient. A sending unit is associated with each sender for transmitting an email from the sender to the server by means of the communication means, and prior to transmittal, encrypting the email using an encryption based a server encryption key. The server further includes means for de-encrypting an email received from a sender using the server encryption key and after de-encrypting, re-encrypting the email using the recipient encryption key uniquely associated with the email's intended particular recipient. A recipient unit is associated with each recipient for receiving an email from the server by means of the communication means, and de-encrypting the received email using the recipient's unique recipient encryption key.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 shows a diagram illustrating a secure email service provided by a service provider in accordance with the present invention.

### DETAILED DESCRIPTION OF THE INVENTION

The following is a detailed description of the preferred embodiments of the invention, reference being made to the drawings in which the same reference numerals identify the same elements of structure in each of the several figures.

The present invention is directed to a Secure Email Service (SES). This Secure Email Service provides a secure email system that automatically applies rule-based encryption to an email, including attachments, that is routed through it. SES can be configured so as to be compatible with existing enterprise firewalls, with SMTP mail systems and can complement a company's (or service provider, for example, Eastman Kodak Company) Security client software, to provide a suite of security products for email messaging.

Existing automatic encryption systems secure messages at the protocol level and leave messages in the clear while they wait for transmission or handling. In contrast, the SES of the present invention provides complete/full end-to-end protection. More particularly, SES is applied at the content level. This allows Secure Email to encrypt and lock down messages and their attachments from point of origin to final destination. SES employs rule-based logic and intuitive keybook management to control the security of email. The system selectively determines which level of encryption, which keys or certificates, and which routing will be used for any sender, recipient, subject matter, content, or attachments. This provides a user with the flexibility to protect enterprise message traffic for organizations that require across-the-board security as well as for those that need protection in specific circumstances.

The system is now more particularly described.

SES is directed to an apparatus and method for securing email on an enterprise-wide basis for communications outside of a firewall. A particular feature of SES is that is can be employed for securing email communications between organizations, worldwide. It can be provided as a turnkey solution. SES promotes interconnectivity between users through a centralized key and message system management. This can reduce/relieve the burden on the users to maintain a list of encryption keys for each one of their email recipients. In addition, SES can conduct advanced anti-virus and malicious software (malware) checks, together with content filtering functions. If keys are centrally managed in a trusted environment, users can send secure email to anyone, anywhere, as long as they have an email address. This can be accomplished if the service provider (system administrator) integrates into the user's existing regular email system (for example, Outlook, Outlook Express, Lotus Notes, GroupWise). This feature also means that after users sign up for the service, operation of SES is transparent.

The encryption can be a standard 256 bit AES (Advanced Encryption Standard) algorithm, approved by the NIST (National Institute of Standards and Technology), and uses both Symmetric and Asymmetric encryption keys. SES encrypts the email message as well as the attachments associated with the message. SES can be operated as a stand-alone enterprise system, as an appliance system, or as part of a Secure Email ASP (Application Service Provider). The ASP can support a plurality of secure email subscribers. SES is directed to three objectives of secure systems: confidentiality of information, data integrity, and authentication.

The Application Service Provider (ASP) delivery model is now more particularly described.

The ASP Secure Email is suitable for use by individuals, small businesses and home offices who want email security but do not have the means to install and maintain their own Secure Email system. ASP Secure Email allows these users/customers to benefit from the advantages of a Secure Email system by solving the problem of key management.

With the system of the present invention, the originator of the secure email has one key, that is, the key the originator uses to receive and decrypt Secure Email messages. The ASP maintains the key of all the subscribers in the system and matches the intended recipient's key to his encryption key on file with the server. This method differs from existing methods wherein the sender of a message has to know the encryption key(s) of each one of his recipients before sending a message.

ASP Secure Email can provide an array of services available for under Enterprise or Appliance applications, including but not limited to: encryption, anti-virus, anti-malware, content filtering, organizational digital signature, and archiving and storage.

System requirements for individual users might be Windows 98, Windows 2000, or Windows XP. Preferably, ASP Secure Email integrates with SMTP based email systems. The ASP Secure Email system can be configured to require a one-time registration, after which operations would be completely transparent to both user and recipient. Preferably, the ASP would provide a set of policy-based rules which can be customized by each user.

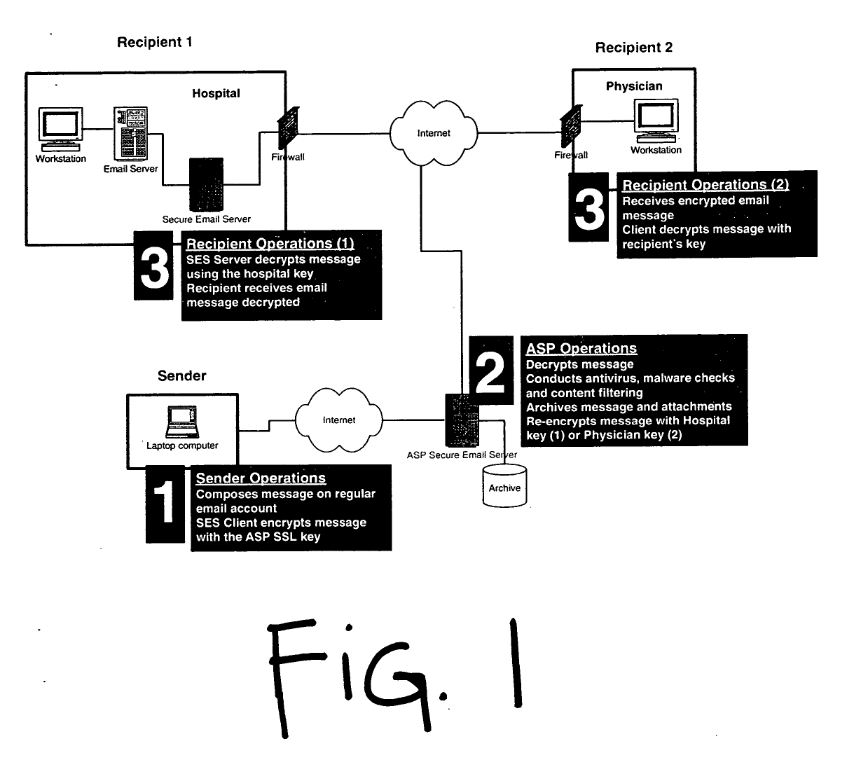

The SES ASP operations is now more particularly described with reference to FIG. 1.

Referring now to FIG. 1, in operation, the sender of the message (shown at number 1 in FIG. 1) composes an email in the sender's standard email application. When the sender selects to send, the message is automatically encrypted with the ASP Server Secure Socket Link (SSL) encryption. Note that this operation requires no key storing on the sender's computer.

When the email is received by the ASP Server (shown at number 2 in FIG. 1), the email is de-encrypted using the SSL encryption key. Once de-encrypted, various processing can be conducted if desired, for example, antivirus and malware checks as well as content filtering. If desired, the message and/or attachments can be archived.

The email is then re-encrypted with the recipient's key and transmitted to the recipient. If the recipient is an individual, then the email is re-encrypted with the recipient's key. If the recipient is part of an enterprise (e.g., a hospital or medical office), then the email is re-encrypted with the recipient's server's key. In all situations, the ASP Server locates the proper key in its key library and requires no key knowledge, and no key exchange, from the sender/originator.

If the recipient of the message is an individual (shown at number 3 in FIG. 1), the recipient receives the encrypted message and de-crypts the message with their key.

If the recipient of the message is an enterprise (shown at number 3 in FIG. 1), the SES Server for the enterprise receives the encrypted message and de-crypts the message with the enterprise's key. Individual recipients associated with the enterprise then receives the email with the message de-crypted.

Accordingly, the ASP model of the present invention provides the ability to manage keys efficiently and without the need for the users to exchange keys prior to sending each other a message.

All documents, patents, journal articles and other materials cited in the present application are hereby incorporated by reference.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method for processing email, comprising the steps of:
receiving, at a server location, an encrypted email from an sender intended for transmission to a predetermined recipient, wherein the email's encryption is based on a first encryption key and the first encryption key is not stored at the remote location, the encrypted email being sent from a sender location remote from the server location;
de-encrypting, at the server location, the received encrypted email using the first encryption key, the first encryption key being stored at the server location;
at the server location, determining a second encryption key associated solely with the predetermined recipient of the email;
re-encrypting the de-encrypted email using an encryption based on the second encryption key; and
transmitting the re-encrypted email to the predetermined recipient located at a recipient location remote from the server location whereby the predetermined recipient can de-encrypt the re-encrypted email at the recipient location using the second encryption key.

2. An email processing system for processing an email transmitted from a sender intended for a particular recipient, comprising:
a server including a database of recipient encryption keys wherein each recipient encryption key is uniquely associated with a particular recipient;
communication means in communication with the server to allow the server to receive an email from a sender and transmit an email to a recipient;
a sending unit associated with each sender for (1) transmitting an email from the sender to the server by means of the communication means, and (2) prior to transmittal, encrypting the email using an encryption based a server encryption key;
the server further including (1) means for de-encrypting an email received from a sender using the server encryption key and (2) after de-encrypting, re-encrypting the email using the recipient encryption key uniquely associated with the email's intended particular recipient; and
a recipient unit associated with each recipient for (1) receiving an email from the server by means of the communication means, and (2) de-encrypting the received email using the recipient's unique recipient encryption key.

3. An email processing system, comprising:
means for receiving, at a server location, an encrypted email from an sender intended for transmission to a predetermined recipient, wherein the email's encryption is based on a first encryption key and the first encryption key is not stored at the remote location, the encrypted email being sent from a sender location remote from the server location;
means for de-encrypting, at the server location, the received encrypted email using the first encryption key, the first encryption key being stored at the server location;
means, at the server location, for determining a second encryption key associated solely with the predetermined recipient of the email;
means at the sever location for re-encrypting the de-encrypted email using an encryption based on the second encryption key; and
means for transmitting the re-encrypted email to the predetermined recipient located at a recipient location remote from the server location whereby the predetermined recipient can de-encrypt the re-encrypted email at the recipient location using the second encryption key.
